(19) United States
(12) Patent Application Publication
(10) Pub. No.: US 2006/0287894 A1
(43) Pub. Date: Dec. 21, 2006

(54) Life settlement business method and program based on actuarial/expectancy data

(76) Inventors: Sanford B. Weiss, Angeles, CA (US); Bruce Rosenfeld, Beverly Hills, CA (US); John Fischer, Berwyn, PA (US)

Correspondence Address: STETINA BRUNDA GARRED & BRUCKER, 75 ENTERPRISE, SUITE 250, ALISO VIEJO, CA, 92656, US

(21) Appl. No.: 11/156,198

(22) Filed: Jun. 17, 2005

(51) Int. Cl. G06Q 40/00; G06F 19/00

(52) U.S. Cl. 705/4; 700/93

(57) ABSTRACT

A method of determining a composite life expectancy of an insured is provided. The composite life expectancy may be for purposes of evaluating issuance of a life settlement policy. The method may include the steps of collecting personal medical data being representative of medical circumstances of the insured; collecting actuarial data being representative of actuarial circumstances of the insured; calculating a medical life expectancy in response to the medical data of the insured; calculating an actuarial life expectancy utilizing a statistical analysis of the actuarial data of the insured relative to other persons of the same actuarial circumstances as the insured; and determining the composite life expectancy in response to an evaluation of the medical life expectancy and the actuarial life expectancy of the insured.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention is directed to a method administering a life settlement insurance program. More specifically, the present invention is directed to a methodology for providing optimized approximations of life the expectancy of an insured for enhancing the feasibility and safeguarding of the life settlement insurance program.

Life settlement programs have developed in recent years that allow an individual having a life insurance policy to receive a settlement payment in return for the assignment of the life insurance policy to another entity. For example, an insured may become ill and need funds to pay for long term health care to allow him to remain his remaining days in comfort and dignity. In such cases an insured might prefer to utilize the policy for his own benefit through a life settlement, rather than transfer those proceeds to others after his death as beneficiaries of the insurance policy. Similarly, an insured may desire to transfer a settlement payment derived from the insurance policy to beneficiaries for their use prior to his death, e.g., to help beneficiaries purchase a home or start a business. In such cases the present value of the settlement payment may be more useful than the future value of the insurance proceeds.

In administering a life settlement program, an insured may typically be required to assign his policy to an owner. As part of the program, the insured may be required to provide certain personal and medical data used to calculate a life expectancy of the insured. Using the life expectancy and the policy value, the program may offer a settlement payment to the insured for assignment of the policy to the owner. For example, a life expectancy of three (3) years may allow an insured to receive a higher settlement payment than if the insured is expected to live for ten (10) years. Once the insured accepts the settlement payment and assigns the policy to the owner, the owner is responsible to maintain the life insurance policies through the regular payment of premiums and other service fees. In this regard, there are numerous expenses associated with the life settlement program in addition to the one time proceeds payout to the insured.

The life settlement program must be funded with moneys collected from investors rather than the insurance company. However, in order to attract investors, a life settlement program must seek to provide a handsome return on the capital investment provided by the investors. Optimally, this return may be comparable to investments that the investor could make or funding for life settlement programs may be unavailable, resulting in the collapse of the life settlement program. In other words, the life settlement programs rely on investor funds, and the investors must be enticed with growth of their investment.

Thus the life settlement program must rely on accurate life expectancy data in order to calculate the feasibility of providing a proceeds payout to an insured.

As a result of the profitability requirements for capital investors; life settlement programs must consider numerous factors before accepting an insured or using investor capital. Ideally, a life settlement program must be able to properly predict the life expectancy of an insured and predict the costs associated with maintenance of the policy in order to know the return on the policy. For example, if money is provided for a life settlement payout and the insured passes within an expected period of time, the investment may be profitable. However, where an insured outlives the life expectancy estimation, the return may be low.

Thus there exists a need in the art to accurately predict the life expectancy of an insured in order to enhance the feasibility of and to safeguard life settlement programs in order to provide life settlement service to insured's. There is a need to accurately predict the life expectancy of an insured in order to more reasonably allot settlement payments to an insured thus safeguarding life settlement funds. Additionally, there exists a need to provide better information and a more precise investment to an investor in such life settlement programs.

### BRIEF SUMMARY OF THE INVENTION

A method of determining a composite life expectancy of an insured is provided for purposes of evaluating issuance of a life settlement policy. The method may include the steps of collecting personal medical data being representative of medical circumstances of the insured; collecting actuarial data being representative of actuarial circumstances of the insured; calculating a medical life expectancy in response to the medical data of the insured; calculating an actuarial life expectancy utilizing a statistical analysis of the actuarial data of the insured relative to other persons of the same actuarial circumstances as the insured; and determining the composite life expectancy in response to an evaluation of the medical life expectancy and the actuarial life expectancy of the insured.

In an aspect of the present invention, the composite life expectancy may be the shorter one of the medical life expectancy and the actuarial life expectancy. Additionally, the composite life expectancy may be determined by discounting the longer of the medical life expectancy and the actuarial life expectancy by the difference between the medical life expectancy and the actuarial life expectancy. In this regard, the longer of the medical life expectancy and the actuarial life expectancy may be reduced by up to the difference between the medical life expectancy and the actuarial life expectancy.

In another aspect of the present invention, the composite life expectancy may be determined by averaging the medical life expectancy and the actuarial life expectancy. The actuarial circumstances may include lifestyle factors, psychological factors, environmental factors, and familial factors of the insured.

In another embodiment of the present invention, a method of determining a composite life expectancy of an insured is provide for purposes of evaluating issuance of a life settlement policy. The method may include the steps of collecting personal medical data being representative of medical circumstances of the insured; collecting actuarial data being representative of actuarial circumstances of the insured; calculating a medical life expectancy in response to the medical data of the insured; calculating an actuarial life 7expectancy utilizing a statistical analysis of the actuarial data of the insured and being relative to other persons of the same actuarial circumstances as the insured; and determining the composite life expectancy by discounting the longer of the medical life expectancy and the actuarial life expectancy by the difference between the medical life expectancy and the actuarial life expectancy.

In accordance with another aspect of the present invention, the step of determining the composite life expectancy may include reducing the longer of the medical life expectancy and the actuarial life expectancy by up to the difference between the medical life expectancy and the actuarial life expectancy.

In yet another embodiment of the present invention, a method is provided for determining a payout date of an investment in a life settlement program. The method may include the steps of collecting personal medical data being representative of medical circumstances of an insured; collecting actuarial data being representative of actuarial circumstances of the insured; collecting administrative data being representative of delays associated with the life settlement program; calculating a medical life expectancy in response to the medical data of the insured; calculating an actuarial life expectancy utilizing a statistical analysis of the actuarial data of the insured and being relative to other persons of the same actuarial circumstances as the insured; determining a composite life expectancy in response to an evaluation of the medical life expectancy and the actuarial life expectancy of the insured; and determining the payout date in response to the composite life expectancy and the administrative data.

In accordance with an aspect of the present invention, the composite life expectancy may be the shorter one of the medical life expectancy and the actuarial life expectancy. Additionally, the composite life expectancy may be determined by discounting the longer of the medical life expectancy and the actuarial life expectancy by the difference between the medical life expectancy and the actuarial life expectancy. In this regard, the longer of the medical life expectancy and the actuarial life expectancy may be reduced by up to the difference between the medical life expectancy and the actuarial life expectancy. In yet another aspect of the present invention, the composite life expectancy may also be determined by averaging the medical life expectancy and the actuarial life expectancy.

### BRIEF DESCRIPTION OF THE DRAWINGS

An illustrative and presently preferred embodiment of the invention is shown in the accompanying drawings in which:

FIG. 1 is a block diagram illustrating a life settlement program in accordance with an aspect of the present invention;

FIG. 2 is a block diagram illustrating a composite life expectancy determinable utilizing personal medical data, actuarial data, medical life expectancy, and actuarial life expectancy;

FIG. 3 is a diagram illustrating exemplary components of medical circumstances and actuarial circumstances of an insured;

FIG. 4 is a flow diagram of an exemplary embodiment of the invention illustrating logic in determining the composite life expectancy; and

FIG. 5 is a diagram illustrating exemplary components of administrative data utilized in determining a payout date.

### DETAILED DESCRIPTION OF THE INVENTION

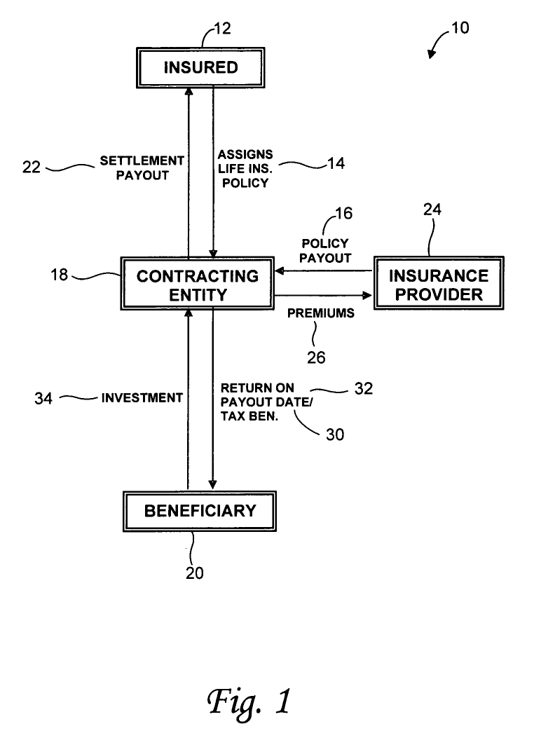

Referring now to the drawings wherein the showings are for purposes of illustrating the preferred embodiment of the present invention only and not for purposes of limiting the same, FIG. 1 is a block diagram illustrating a life settlement program 10 in accordance with an aspect of the present invention. The life settlement program 10 may include an insured 12 possessing a life insurance policy 14 with a policy payout 16 and a contracting entity 18 for contracting with the insured 12 for assignment of the policy to a beneficiary 20 in exchange for a settlement payout 22 to the insured 12. It is contemplated that the beneficiary 20 may be an investor. An insurance provider 24 may receive premiums 26 paid by the contracting entity 18 for maintenance of the life insurance policy 14 and may later provide the policy payout 16 to the contracting entity 18 upon death of the insured 12. According to an aspect of the present invention, a method for determining a composite life expectancy 28 may help determine a payout date 30 representative of the time when the beneficiary 20 receives a return 32 on an investment 34.

Although it is contemplated that an embodiment of the present invention is utilized in conjunction with the sale and distribution of life insurance policies, it is also contemplated that another embodiment of the present invention may be utilized in conjunction with the sale and distribution of other finds with a long term purpose. For example, instead of using the life insurance policy 14, embodiments of the present invention may utilize pension funds, endowment funds, and the like. Therefore, the same principles and teachings that are provided herein regarding life insurance policies are exemplary and may be utilized in conjunction with other funds as desired.

It is also contemplated that the contracting entity 18 may utilize outside vendors to provide services associated with the maintenance of the life insurance policy 14. For example, the contracting entity 18 may utilize a trustee or escrow agent to handle the funds, manage the life insurance policy 14, or perform other functions as desired by the contracting entity 18. Indeed, as will be recognized by those skilled in the field, a system level implementation of the life settlement program 10 may be modified by rearrangement or redistribution of component features or elements of the life settlement program 10. Moreover, the individual component elements may be modified by substitution of equivalent components intended to provide the same or equivalent results. Accordingly, the described life settlement program 10 is not intended to be limiting of the broad aspects of the present invention.

In accordance with another aspect of the present invention, it is contemplated that the contracting entity 18 may offer a “guarantee program” to the beneficiary 20. The guarantee program may be implemented to guarantee the return 32 on investment either in terms of quantity or time. The return 32 may refer to the total investment made by the investor or partial amounts thereof, as well as any interest, increase, dividend, etc. on the investment. As an aspect of the “guarantee program,” the contracting entity 18 provides the beneficiary 20 with a designated date whereon the beneficiary 20 will receive the return 32. Implementations of the guarantee program may therefore utilize the composite life expectancy 28 and other factors described herein. Further, the contracting entity 18 may offer other incentives to the beneficiary 20 in order to mitigate risks associated with investing in life settlement. The contracting entity 18 may also provide a “contestable period guarantee” to the beneficiary 20. As an aspect of the “contestable period guarantee,” the contracting entity 18 may protect the beneficiary 20 against actions taken by the insurance provider 24 that result in losses during the contestable period of the insurance policy 14.

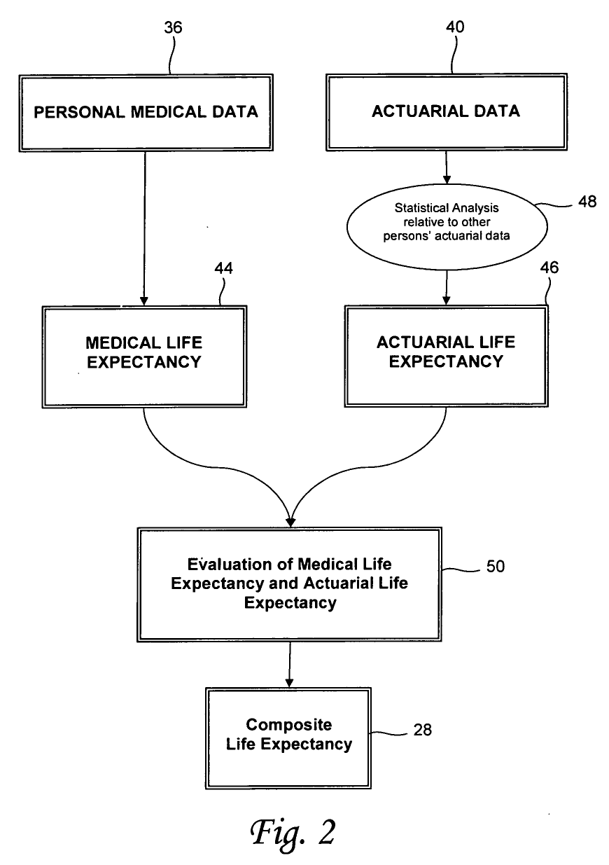

As shown in FIG. 2, the method of determining a composite life expectancy 28 of an insured 12 may include the steps of collecting personal medical data 36 being representative of medical circumstances 38 of the insured 12; collecting actuarial data 40 being representative of actuarial circumstances 42 of the insured 12; calculating a medical life expectancy 44 in response to the medical data of the insured 12; calculating an actuarial life expectancy 46 utilizing a statistical analysis 48 of the actuarial data 40 of the insured 12 relative to other persons of the same actuarial circumstances 42 as the insured 12; and determining the composite life expectancy 28 in response to an evaluation of the medical life expectancy 50 and the actuarial life expectancy 46 of the insured 12. It is contemplated that the composite life expectancy 28 may be used to determine the amount of the settlement payout 22. Additionally, the composite life expectancy 28 may be utilized for other informational purposes in relation to the administration of the life settlement program 10.

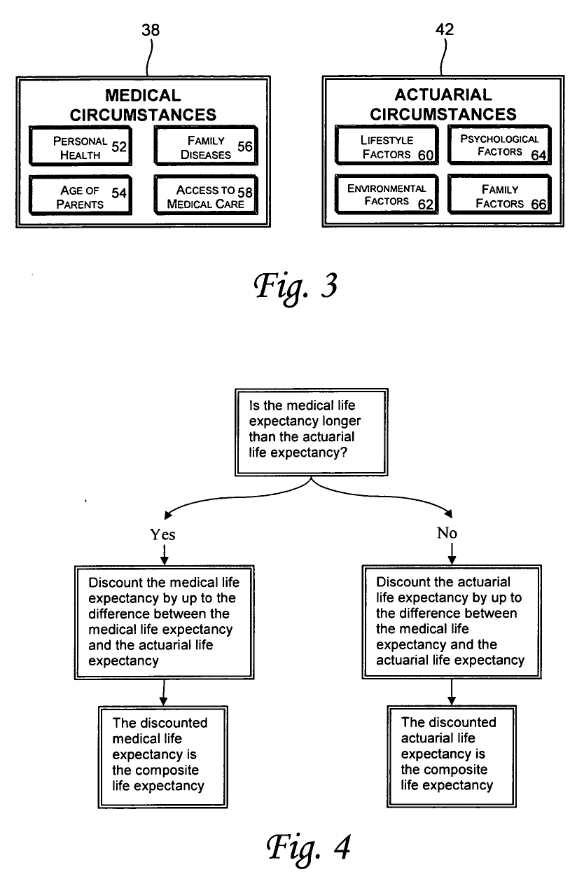

Referring again to FIG. 3, it is contemplated that the medical circumstances 38 of the insured 12 may include data such as personal health 52, age of the insured's parents 54, family diseases 56, and the insured's access to medical care 58 throughout the insured's life. However, these factors are provided only to illustrate an exemplary embodiment and not to limit the same; medical circumstances 38 may include limitless details regarding the insured's medical condition or other medical details. The personal medical data 36 may be collected from the insured 12 through a questionnaire, an interview, personal medical records, or other means reasonable under the circumstances. In this regard, the personal medical data 36 obtained from a given insured 12 may be different in scope and detail than that obtained from another insured 12.

Additionally, as also seen in FIG. 3, it is contemplated that the actuarial circumstances 42 may include lifestyle factors 60, environmental factors 62, psychological factors 64, and family related factors 66. However, these factors are provided only to illustrate an exemplary embodiment and not to limit the same; actuarial circumstances 42 may include limitless details regarding the insured's life and experiences. The lifestyle factors 60 may refer to the education, career, drug and alcohol usage, as well as exercise and/or other activities that may involve relatively high risk. The environmental factors 62 may include information such as the current domicile of the insured 12, past domiciles of the insured 12, and information related to those domiciles including items such as air quality, rates of disease, injury or death in a population of that domicile, crime rates, and other various information. The psychological factors 64 may be determined by evaluating the explanatory style of the insured 12 through a psychological test such as the Minnesota Multi-Phasic Personality Inventory (MMPI). The family factors may include information regarding the insured's family such as any living relatives, the marital status of the insured 12, and the age of the insured's siblings, if any. It is contemplated that numerous other factors may be included in the actuarial data 40, and the aforementioned factors are mentioned only to illustrate a particular embodiment of the present invention. In this regard, the new “life tables” may be formulated for the technical assessment of the life expectancy 36. Such “life tables” may be distinct from standard actuarial tables such as the Standard Mortality Tables of 1959.

Referring again to FIG. 2, it is contemplated that the composite life expectancy 28 may be determined in response to an evaluation of the medical life expectancy 50 and the actuarial life expectancy 46 of the insured 12. In this regard, the composite life expectancy 28 may be the shorter one of the medical life expectancy 44 and the actuarial life expectancy 46. Additionally, as shown in FIG. 4, the composite life expectancy 28 may be determined by discounting the longer of the medical life expectancy 44 and the actuarial life expectancy 46 by the difference between the medical life expectancy 44 and the actuarial life expectancy 46. In an aspect of the present invention, the composite life expectancy 28 may be determined as the longer of the medical life expectancy 44 and the actuarial life expectancy 46 reduced by up to the difference between the medical life expectancy 44 and the actuarial life expectancy 46. Further, the composite life expectancy 28 may also be determined by averaging the medical life expectancy 44 and the actuarial life expectancy 46.

In accordance with another embodiment of the present invention, a method of determining a composite life expectancy 28 of an insured 12 for purposes of evaluating issuance of a settlement payout 22 is provided. As illustrated in FIGS. 2 and 4, the method may comprise the steps of collecting personal medical data 36 being representative of medical circumstances 38 of the insured 12; collecting actuarial data 40 being representative of actuarial circumstances 42 of the insured 12; calculating a medical life expectancy 44 in response to the medical data of the insured 12; calculating an actuarial life expectancy 46 utilizing a statistical analysis 48 of the actuarial data 40 of the insured 12 relative to other persons of the same actuarial circumstances 42 as the insured 12; and determining the composite life expectancy 28 by discounting the longer of the medical life expectancy 44 and the actuarial life expectancy 46 by the difference between the medical life expectancy 44 and the actuarial life expectancy 46. In this regard, as shown in FIG. 4, the composite life expectancy 28 may also be determined by reducing the longer of the medical life expectancy 44 and the actuarial life expectancy 46 by up to the difference between the medical life expectancy 44 and the actuarial life expectancy 46. Nevertheless, it is contemplated that the medical life expectancy 44 and the actuarial life expectancy 46 may be manipulated in various other ways to determine the composite life expectancy 28.

According to another embodiment of the present invention, a method of determining a payout date 30 of an investment 34 in a life settlement program 10 is provided. As illustrated in FIGS. 2 and 4, the method may include the steps of collecting personal medical data 36 being representative of the medical circumstances 38 of an insured 12; collecting actuarial data 40 being representative of actuarial circumstances 42 of an insured 12; collecting administrative data 68 being representative of delays 70 associated with the life settlement program 10; calculating a medical life expectancy 44 in response to the medical data of the insured 12; calculating an actuarial life expectancy 46 utilizing a statistical analysis 48 of the actuarial data 40 of the insured 12 relative to other persons of the same actuarial circumstances 42 of the insured 12; determining a composite life expectancy 28 in response to an evaluation of the medical life expectancy 50 and the actuarial life expectancy 46 of the insured 12; and determining the payout date 30 in response to the composite life expectancy 28 and the administrative data 68.

Referring again to FIG. 1, it is contemplated that the payout date 30 may provide the beneficiary 20 with an estimated time whereon the investment 34 will mature and provide a return 32 to the beneficiary 20. As shown in FIG. 1, the return 32 may include a tax benefit as well. The payout date 30 may also provide the contracting entity 18 with valuable information that may allow the contracting entity 18 to structure the terms of the investment 34 in response to the payout date 30. In this regard, as those of skill in the art may know, as the contracting entity 18 obtains more accurate information as to the timing of the policy payout 16, the contracting entity 18 may provide a more secure investment opportunity to the beneficiary 20. This may result in increased business and additional opportunities to an insured 12 for receiving settlement payouts 22.

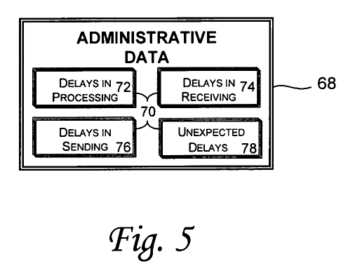

Shown in FIG. 5, it is contemplated that the administrative data 68 may include information related to the delays 70 associated with the life settlement program 10. Such delays 70 may include delays in processing 72, receiving 74, or sending 76 the policy payout 16 from the insurance provider 24 or the return 32 to the beneficiary 20. These delays 70 may originate at the insurance provider 24 or at the contracting entity 18. Additionally, it is contemplated that the administrative data 68 may include unexpected delays 78 that the contracting entity 18 discovers in the course of administering the life settlement program 10.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

What is claimed is:

1. A method of determining a composite life expectancy of an insured for purposes of evaluating issuance of a settlement payout, the method comprising:
a. collecting personal medical data being representative of medical circumstances of the insured;
b. collecting actuarial data being representative of actuarial circumstances of the insured;
c. calculating a medical life expectancy in response to the medical data of the insured;
d. calculating an actuarial life expectancy utilizing a statistical analysis of the actuarial data of the insured relative to other persons of the same actuarial circumstances as the insured; and
e. determining the composite life expectancy in response to an evaluation of the medical life expectancy and the actuarial life expectancy of the insured.

2. The method of claim 1 wherein the composite life expectancy is the shorter one of the medical life expectancy and the actuarial life expectancy.

3. The method of claim 1 wherein the composite life expectancy is determined by discounting the longer of the medical life expectancy and the actuarial life expectancy by the difference between the medical life expectancy and the actuarial life expectancy.

4. The method of claim 3 wherein the longer of the medical life expectancy and the actuarial life expectancy is reduced by up to the difference between the medical life expectancy and the actuarial life expectancy.

5. The method of claim 1 wherein the composite life expectancy is determined by averaging the medical life expectancy and the actuarial life expectancy.

6. The method of claim 1 wherein the actuarial circumstances include lifestyle factors, psychological factors, environmental factors, and familial factors of the insured.

7. A method of determining a composite life expectancy of an insured for purposes of evaluating issuance of a life settlement policy, the method comprising:
a. collecting personal medical data being representative of medical circumstances of the insured;
b. collecting actuarial data being representative of actuarial circumstances of the insured;
c. calculating a medical life expectancy in response to the medical data of the insured;
d. calculating an actuarial life expectancy utilizing a statistical analysis of the actuarial data of the insured relative to other persons of the same actuarial circumstances as the insured; and
e. determining the composite life expectancy by discounting the longer of the medical life expectancy and the actuarial life expectancy by the difference between the medical life expectancy and the actuarial life expectancy.

8. The method of claim 7 wherein step (e) includes reducing the longer of the medical life expectancy and the actuarial life expectancy by up to the difference between the medical life expectancy and the actuarial life expectancy.

9. A method of determining a payout date of an investment in a life settlement program, the method comprising:
a. collecting personal medical data being representative of medical circumstances of an insured;
b. collecting actuarial data being representative of actuarial circumstances of the insured;
c. collecting administrative data being representative of delays associated with the life settlement program;
d. calculating a medical life expectancy in response to the medical data of the insured;
e. calculating an actuarial life expectancy utilizing a statistical analysis of the actuarial data of the insured relative to other persons of the same actuarial circumstances as the insured;
f. determining a composite life expectancy in response to an evaluation of the medical life expectancy and the actuarial life expectancy of the insured; and
g. determining the payout date in response to the composite life expectancy and the administrative data.

10. The method of claim 9 wherein the composite life expectancy is the shorter one of the medical life expectancy and the actuarial life expectancy.

11. The method of claim 9 wherein the composite life expectancy is determined by discounting the longer of the medical life expectancy and the actuarial life expectancy by the difference between the medical life expectancy and the actuarial life expectancy.

12. The method of claim 11 wherein the longer of the medical life expectancy and the actuarial life expectancy is reduced by up to the difference between the medical life expectancy and the actuarial life expectancy.

13. The method of claim 9 wherein the composite life expectancy is determined by averaging the medical life expectancy and the actuarial life expectancy.
